(19) United States
(12) Patent Application Publication
(10) Pub. No.: US 2025/0224503 A1
(43) Pub. Date: Jul. 10, 2025

(54) METHOD FOR INCLUDING BISTATIC PATHS IN ANGLE ESTIMATION USING A COOPERATIVE RADAR SENSOR NETWORK

(71) Applicant: Robert Bosch GmbH, Stuttgart (DE)

(72) Inventors: Daniel Schindler, Korntal-Münchingen (DE); Tobias Schmid, Fluorn-Winzeln (DE); Benedikt Loesch, Stuttgart (DE)

(21) Appl. No.: 19/004,938

(22) Filed: Dec. 30, 2024

(30) Foreign Application Priority Data
Jan. 9, 2024 (DE) 10 2024 200 175.9

(51) Int. Cl. G01S 13/42; G01S 13/00

(52) U.S. Cl. CPC G01S 13/42; G01S 13/003

(57) ABSTRACT

A method for a cooperative radar sensor network having a plurality of individual radar sensors, for estimating an angle of a radar target or for preparing the radar sensor network therefor. An association that associates a control vector (A_{α}) having bistatic components with each of a plurality of angles is determined. A measurement vector associated with a detected radar target is calculated, wherein the measurement vector has bistatic components.

### CROSS REFERENCE

The present application claims the benefit under 35 U.S.C. § 119 of Germany Patent Application No. DE 10 2024 200 175.9 filed on Jan. 9, 2024, which is expressly incorporated herein by reference in its entirety.

### FIELD

The present invention relates to angle estimation by means of a cooperative radar sensor network. In particular, the present invention relates to a method for a cooperative radar sensor network having a plurality of individual radar sensors, for preparing the cooperative radar sensor network for bistatic angle estimations. Furthermore, the present invention relates to a method for a cooperative radar sensor network having a plurality of individual radar sensors, for estimating an angle of a radar target.

### BACKGROUND INFORMATION

Radar sensors are used in motor vehicles to implement comfort functions such as adaptive cruise control and safety functions such as emergency braking assistants. The main advantage of such sensors is the direct measurement of physical variables instead of, for example, interpreting images from a video camera. The radar sensors emit radio-frequency radar beams via their antenna array and receive the beams reflected from objects. The detected objects can be stationary or moving. With the aid of the received radar beams, the distance and direction (angle) to the object can be calculated. In addition, the velocity of an object relative to the radar sensor can be calculated.

During angle estimation, the reception signals are compared to a previously measured, angle-dependent antenna radiation pattern. In case only a single target is located (or a plurality of targets that can be clearly distinguished from one another based on their distance and relative velocity), the estimated angle is the position of the best match between the reception signal and the antenna radiation pattern. For the general case of multi-target estimation, special estimation algorithms are available, which provide estimated values for the detection angles of all targets involved.

The performance of environmental detection can be significantly improved by using a cooperative radar sensor network. In this case, the data from a plurality of radar sensors are evaluated together in a phase-coherent manner, which allows for increased sensitivity on the one hand and increased accuracy of environmental detection on the other hand since a larger antenna array and more RF channels are available overall than in the single sensor.

Current non-phase-coherent radar sensor networks for motor vehicles typically operate monostatically. In other words, a radar target is detected by a particular radar sensor that emits a signal and receives the signal reflected from the radar target. In angle-resolving measurement, reception antenna elements are arranged in different positions on a particular radar sensor in a direction in which the radar sensor is angle-resolving. For an idealized, approximately point-like radar target at a particular angular position, there is a characteristic phase and amplitude relationship between the signals received in different reception antenna elements for a transmitted signal. The amplitude ratios between the received signals depend on the directional angle and the sensitivity curves of the reception antenna elements. By evaluating the phase relationships and/or the amplitude relationships, it is possible to determine the angular position of a located radar target. For estimating the angle of a detected radar target, signal processing steps are typically performed separately for each combination of transmission and reception antenna elements of a particular individual sensor. Such a combination corresponds to what is known as a monostatic path of the radar sensor network. The angle estimation is then carried out based on the combined values of the spectra of the individual monostatic paths of the radar sensor, which values correspond to a detected target. The particular radar sensor is calibrated by measuring an antenna radiation pattern of the particular radar sensor, in particular by creating a calibration matrix for the monostatic paths of the radar sensor.

German Patent No. DE 10 2019 201 138 A1 describes a sensor system and a method for calibrating radar sensor nodes of the sensor system, in which two radar sensor nodes are arranged at a distance from each other on the vehicle. The transmission elements and the reception elements of the first radar sensor node form a node-local field of aperture elements of a virtual reception aperture, and the transmission elements of the first radar sensor node and the reception elements of the second radar sensor node form a cross-node field of aperture elements of a virtual reception aperture. A distance between the two radar sensor nodes and a distance between the transmission elements and reception elements within the first radar sensor node are selected such that a position of a first aperture element of the node-local field corresponds to a position of a second aperture element of the cross-node field. This allows a calibration of the first radar sensor node to be transferred to the second radar sensor node, thus avoiding complex calibration of the plurality of radar sensor nodes.

### SUMMARY

In phase-coherent, cooperatively operating radar sensor networks, radar sensors are operated in a phase-coherent or phase-synchronized manner in a system network so that the transmission signals of the individual radar sensors have a fixed phase relationship to one another. This makes it possible to evaluate not only the individual-sensor-related radar signals of the monostatic paths but also bistatic paths, in which radar signals are transmitted by a transmission antenna element of one radar sensor and received by a reception antenna element of another radar sensor. However, compared to an individual radar sensor, cooperative radar sensor networks are usually very large and are only brought into their final geometric arrangement when installed, for example in a vehicle. Therefore, it is impossible or difficult to perform calibration measurements with the cooperative radar sensor network, in particular in an antenna measurement chamber, in order to create a calibration matrix of the bistatic paths or of the entire radar sensor network.

An object of the present invention is to provide a method for a cooperative radar sensor network that allows for an improvement in the angle estimation performance and/or immensely reduces the calibration effort of cooperatively operating systems.

It is in particular an object of the present invention to allow an angle evaluation of the bistatic paths of the cooperative radar sensor network without measuring a calibration matrix of the bistatic paths or of the entire radar sensor network.

A further object of the present invention is to allow an angle evaluation on the full aperture of the cooperative radar sensor network without measuring a calibration matrix of the bistatic paths or of the entire radar sensor network.

At least one of the above objects is achieved according to a first aspect of the present invention by a method for a cooperative radar sensor network having a plurality of individual radar sensors, for preparing the cooperative radar sensor network for bistatic angle estimations. According to an example embodiment of the present invention, the method comprises: determining an association that associates a particular control vector with each of a plurality of angles, wherein the particular control vector has at least bistatic components, wherein a bistatic l-th component of the control vector corresponds to a product of: a particular first monostatic component of a control vector of a particular first of the radar sensors, wherein the first monostatic component corresponds to a monostatic path from an m-th transmission antenna element of the first radar sensor to an n-th reception antenna element of the first radar sensor; and a particular second monostatic component of a control vector of a particular second of the radar sensors, wherein the second monostatic component corresponds to a monostatic path from an m-th transmission antenna element of the second radar sensor to an n-th reception antenna element of the second radar sensor.

In this case, l is a natural number. Furthermore, m and n are natural numbers. For example, for a plurality of l, the bistatic l-th component of the control vector can correspond to a product as indicated, wherein, for each l, the numbers m and n can correspond to different combinations of transmission and reception antenna elements of the respective radar sensors.

The cooperative radar sensor network can in particular be a phase-coherent, cooperative radar sensor network. In a phase-coherent, cooperative radar sensor network, the individual radar sensors have a fixed relationship between the phases of their transmission signals. The individual radar sensors can have the same fundamental frequency (radar fundamental frequency) or different fundamental frequencies.

In the context of a cooperative radar sensor network, the term “bistatic” refers to radar signal paths from a transmission antenna element to a reception antenna element via a radar target, where the transmission antenna element and the reception antenna element belong to different radar sensors of the radar sensor network. Such paths can also be referred to as bistatic paths or as paths spanning the radar sensors involved. The corresponding channels (evaluation channels or transmission/reception channels) are referred to here as bistatic channels. In contrast, the term “monostatic” refers to radar signal paths in which the transmission antenna element and the reception antenna element belong to the same radar sensor in the radar sensor network. Such paths can also be referred to as monostatic paths or as paths limited to an individual radar sensor. The corresponding channels (evaluation channels or transmission/reception channels) are referred to here as monostatic channels. Unless otherwise stated, the terms “control vectors,” “channels” and “signal paths” here refer to transmission/reception control vectors, transmission/reception channels and transmission/reception signal paths.

A bistatic angle estimation is an angle estimation (estimation of the angle of a radar target) taking into account signals from at least one bistatic path of the radar sensor network. In particular, the method of the present invention can be a method for preparing the cooperative radar sensor network for bistatic angle estimations by including signals from (a plurality of) bistatic paths of the radar sensor network. The angle to be estimated may, for example, be an azimuth angle. The angle to be estimated may also be an elevation angle or a combination of elevation and azimuth angle.

According to an example embodiment of the present invention, the radar sensors each have a plurality of transmission antenna elements and/or a plurality of reception antenna elements. In particular, the radar sensors each have an antenna array, which comprises a plurality of transmission antenna elements and/or a plurality of reception antenna elements. The plurality of transmission antenna elements and/or the plurality of reception antenna elements are arranged in different positions on a particular radar sensor in a direction in which the radar sensor or the cooperative radar sensor network is angle-resolving. For example, the radar sensors each have at least Nₜₓ transmission antenna elements and at least Nᵣₓ reception antenna elements. Preferably, the Nᵣₓ reception antenna elements are arranged in different positions on a particular radar sensor in a direction in which the radar sensor or the cooperative radar sensor network is angle-resolving. In preferred embodiments, the individual radar sensors are MIMO (multiple-input, multiple-output) radar sensors each having at least Nₜₓ transmission antenna elements and at least Nᵣₓ reception antenna elements. In order that the signals from the transmission antenna elements can be separated at the reception antenna elements, the transmission signals must be uncorrelated (orthogonal). This can be achieved via time, frequency or code division multiplexing.

The bistatic components of the control vector that correspond to a product of respective monostatic components of control vectors of the respective radar sensors are hereinafter also referred to as bistatic product components.

A control vector indicates the geometric properties and wave propagation characteristics of the antenna array under consideration. Knowledge of the control vector makes it possible to establish a relationship (unambiguous under appropriate conditions) between the angle of the object (or “radar target”) and the received signals and to infer the angle of the object from the amplitude and phase relationships of the received signals. In particular, a control vector indicates expected phase relationships between components of a corresponding measurement vector. An individual component of a control vector can indicate the expected amplitude and the expected phase position of a signal of a respectively associated channel (transmission/reception channel) or channel product of a radar sensor, in particular for the angle with which the control vector is associated. In the case of a bistatic product component of a control vector, this relates to signals of the respectively associated bistatic channels and corresponding bistatic paths of the radar sensor network. The control vector that comprises a bistatic product component can also be called a product control vector. In addition to the bistatic components, the particular control vector can also have monostatic components that can correspond to the respective monostatic components of control vectors of the individual radar sensors.

The particular control vector that has the bistatic components can be called a bistatic control vector.

According to an example embodiment of the present invention, the association that associates a particular control vector with each of a plurality of angles can, for example, be a control matrix and can also be called a calibration matrix or antenna radiation pattern. In the following, determining the association is also referred to as creating a calibration matrix. Each row of the control matrix can correspond to the control vector associated with a particular angle.

An l-th bistatic component of a control vector is understood to be the l-th component of the control vector, i.e., one of the components of the control vector, wherein the component is a bistatic component. It corresponds to a (complex) product of the particular first monostatic component of a control vector of the particular first radar sensor and the particular second monostatic component of a control vector of the particular second radar sensor. In particular, it can be the product. The product comprises at least an addition of the relevant phases of the respective monostatic components of the control vectors under consideration. For example, the aforementioned monostatic components of the control vectors of the radar sensors can be complex numbers and indicate an amplitude and a phase. In this case, a product of the two monostatic components corresponds to a multiplication of their amplitudes and an addition of their phases. The aforementioned components of the control vectors can also indicate only a phase if the respective amplitudes are neglected. In this case, the product of the two monostatic components corresponds to an addition of their phases.

According to an example embodiment of the present invention, the method can comprise: storing or keeping available (e.g., in a memory) calibration matrices of the individual sensors and/or element-wise products of the respective matrices across all virtual channels and angular deviations.

The method of the present invention may have the advantage that, for preparing the cooperative radar sensor network for bistatic angle estimations, the association that associates a particular control vector with each of a plurality of angles is determined, wherein the control vector can be calculated based on monostatic components of control vectors of the individual radar sensors. Thus, control vectors having bistatic components can be calculated and the association can be determined without the need for complex measurement of the bistatic components of the installed radar sensor network. In particular, the bistatic components of the particular control vector can be calculated based on (monostatic) control vectors of the individual radar sensors. Control vectors or calibration matrices or antenna radiation patterns of the individual radar sensors associated with respective angles can, for example, have been determined in the usual way by calibration measurements of the individual radar sensors. For example, they can be measured for each individual sensor at the factory before the radar sensor network is installed. The association can be determined, for example, before the radar sensor network is put into practical use, for example after the cooperative radar sensor network has been installed.

Determining the association thus makes it possible to allow an angle evaluation of the bistatic paths of the cooperative radar sensor network or to prepare the cooperative radar sensor network for bistatic angle estimations without measuring a calibration matrix of the bistatic paths or of the entire radar sensor network. This allows for an improvement in the angle estimation performance of the cooperative radar sensor network. Since the bistatic paths can also be used for angle evaluation, a much larger virtual antenna aperture can be spanned. A calibration of the entire cooperative system can be derived based on a monostatic calibration of the individual sensors used.

This takes advantage of the fact that, if the distance or spatial offset between the m-th transmission antenna element and the n-th reception antenna element of the first radar sensor corresponds to the distance or spatial offset between the m-th transmission antenna element and the n-th reception antenna element of the second radar sensor, as is typically the case, for example, with two identically constructed radar sensors or radar sensors having identically constructed antenna arrays, the association and control vectors determined in this way are particularly suitable for use in angle estimation. It can then be assumed that the two bistatic virtual channels that correspond to a bistatic path from the m-th transmission element of the first radar sensor to the n-th transmission element of the second radar sensor or to a bistatic path from the m-th transmission element of the second radar sensor to the n-th transmission element of the first radar sensor are redundant insofar as the two bistatic virtual channels correspond to the same virtual spatial antenna position. The complex spectral values at the spatial positions of the virtual bistatic channels on the virtual sensors are therefore redundant. It is then true for a detected ideal radar target at an angular position that the bistatic l-th component of the control vector associated with the angle corresponds to the product of: a measured value of a bistatic channel, which measured value is associated with the radar target and which bistatic channel corresponds to the m-th transmission antenna element of the first radar sensor and the n-th reception antenna element of the second radar sensor; and a measured value of a bistatic channel, which measured value is associated with the radar target and which bistatic channel corresponds to the m-th transmission antenna element of the second radar sensor and the n-th reception antenna element of the first radar sensor. This equality applies to a virtual spatial antenna position. The product of the spectral values in the d, v spectrum (distance/velocity spectrum) measured in the two redundant bistatic channels for a radar target can therefore be evaluated for an angle estimation by means of the corresponding bistatic components of the control vectors associated with the respective angles. In the present disclosure, for simplifying the representation, radar targets are assumed to be in the far field.

The individual radar sensors, each comprising monostatic channels, are also referred to below as real radar sensors. In contrast, a bistatic virtual sensor (or radar sensor) comprises bistatic channels corresponding to the bistatic paths created by combinations of transmission antenna elements and reception antenna elements of two different real radar sensors. The individual radar sensors and bistatic virtual sensors are collectively referred to below as the real or virtual sensors (or radar sensors) and can also be referred to as real or virtual sensor nodes. Here, the term “subaperture” refers to the apertures of the individual real and bistatic virtual sensors, as opposed to the total aperture of the radar sensor network.

At least one of the aforementioned objects is achieved according to a second aspect of the disclosure by a method for a cooperative radar sensor network having a plurality of individual radar sensors, for estimating an angle of a radar target, wherein the method comprises: calculating a measurement vector associated with a detected radar target, wherein the measurement vector has at least bistatic components, wherein a bistatic l-th component of the measurement vector corresponds to a product of: a measured value of a bistatic channel, which measured value is associated with the radar target and which bistatic channel corresponds to an m-th transmission antenna element of a particular first of the radar sensors and an n-th reception antenna element of a particular second of the radar sensors; and a measured value of a bistatic channel, which measured value is associated with the radar target and which bistatic channel corresponds to an m-th transmission antenna element of the second radar sensor and an n-th reception antenna element of the first radar sensor, wherein the method furthermore comprises: estimating the angle of the detected radar target, wherein the estimated angle is determined based on a result of correlating the measurement vector with control vectors associated with different angles or is determined based at least on a product of the measurement vector with a control vector.

The method according to the second aspect of the present invention is complementary to the method according to the first aspect of the present invention in that the method according to the first aspect serves to prepare the method according to the second aspect. The angle is in particular estimated in the practical use of the radar sensor network. The following explanations complement the above explanations of the first aspect, which are not repeated here.

According to an example embodiment of the present invention, for detecting a radar target, a baseband signal is generated from a reception signal, received by a reception antenna element, by mixing it with a transmission signal, transmitted by a transmission antenna element, and this baseband signal is sampled and evaluated. The frequency and phase of the baseband signal correspond to the frequency difference and phase difference between the signal transmitted at a given time and the signal received at the same time. Due to the frequency modulation of the transmission signal, this frequency difference depends on the propagation time of the signal from the radar sensor to the object and back and thus on the distance of the object. However, due to the Doppler effect, the frequency difference also contains a component that is caused by the relative velocity of the object.

The described method of the present invention and the determination of the measurement vector for a detected radar target can be used advantageously in particular in a cooperative radar sensor network having FMCW radar sensors that work with what are known as rapid chirp sequences. A plurality of frequency ramps (chirps) are passed through in rapid succession, each of which has a large slope and only a relatively short duration. A d, v spectrum can then be calculated for a channel by Fourier transform, where bin coordinates of the spectrum, each corresponding to the distance d or the relative velocity v, are associated with a radar target detected as a peak.

A measurement vector the components of which correspond to different configurations of transmission antenna elements and/or reception antenna elements of the radar sensor network can thus be obtained for a detected radar target (object). The measurement vector has at least bistatic components. A bistatic component of the measurement vector corresponds to a product of respective channels (transmission/reception channels) of a particular bistatic virtual sensor, more precisely to a (complex) product of the measured values (in particular spectral values of two-dimensional spectra or d, v spectra of bistatic channels) of the respective bistatic channels associated with the detected radar target. In particular, it can be the product. An l-th bistatic component of the aforementioned measurement vector is understood to be the l-th component of the measurement vector, i.e., one of the components of the measurement vector, wherein the component is a bistatic component. In particular, the measurement vector can be compiled and/or calculated from the measured values of the individual transmission/reception channels, which measured values are available as vectors, for example, wherein the product components are calculated for the bistatic components. The product comprises at least an addition of the relevant phases of the respective measured values of the bistatic channels under consideration associated with the radar target. For example, the aforementioned measured values of the bistatic channels under consideration can be complex numbers and indicate an amplitude and a phase. In this case, a product of the two measured values corresponds to a multiplication of their amplitudes and an addition of their phases. The aforementioned measured values of the bistatic channels under consideration can also indicate only a phase if the respective amplitudes are neglected. In this case, the product of the two measured values corresponds to an addition of their phases.

According to an example embodiment of the present invention, the measurement vector can furthermore have monostatic components, which can correspond to respective channels (transmission/reception channels) of a particular individual radar sensor. A component of the measurement vector thus corresponds to the indicated product of bistatic channels in the bistatic case and can correspond to a monostatic channel of the corresponding radar sensor in the monostatic case. The components of the measurement vector are based on measured values obtained in respective channels for a detected radar target. For an individual radar sensor, the components of the measurement vector can correspond to the measured values obtained in respective channels of the radar sensor for a detected radar target.

As described above, the measured values of the two bistatic virtual channels that correspond to a bistatic path from the m-th transmission element of the first radar sensor to the n-th reception element of the second radar sensor or to a bistatic path from the m-th transmission element of the second radar sensor to the n-th reception element of the first radar sensor can be redundant. In other words, the relevant channels can be redundant. Due to the above-described correspondence between the bistatic l-th component of the above-described control vector associated with the angle and the corresponding bistatic l-th component of the measurement vector, the product of the spectral values in the d, v spectrum measured in the two redundant bistatic channels for a radar target can therefore be evaluated for the angle estimation by means of corresponding bistatic components of control vectors associated with the respective angles, wherein the bistatic components of the control vectors can correspond to products of monostatic components of control vectors of the individual radar sensors and can therefore be determined without measuring a calibration matrix of the bistatic paths or of the entire radar sensor network.

The measurement vector having the bistatic components corresponding to the aforementioned products is therefore particularly advantageous for angle estimation since it allows angle estimation by including bistatic paths, without having to measure a calibration matrix of the bistatic paths or of the entire radar sensor network.

In example embodiments of the present invention, a particular measurement vector is obtained for each real and virtual sensor, wherein the measurement vector of a virtual sensor has the bistatic components. In other embodiments, the measurement vector comprises channels of each of the real and virtual sensors. The method can comprise: performing a radar measurement to locate the radar target. The method or performing the radar measurement can comprise: calculating distance/velocity spectra (d, v spectra) at least in bistatic channels.

For the angle estimation, advantage is taken of the fact that the amplitude and phase relationships of the signals received in at least the different bistatic channels depend in a characteristic manner on the angle of the radar target. The phase characteristic across the channels of a particular real or virtual sensor is determined by the angle of an (ideal) radar target. By means of correlation, the phase information of the individual components of the measurement vector is included in the estimation of the angle, taking into account the corresponding control vector. Correlating a measurement vector associated with a detected radar target with control vectors associated with different angles and determining the estimated angle based on the result of the correlation can also be referred to as: examining how strongly a measurement vector associated with a detected radar target correlates with control vectors associated with different angles, and estimating the angle of the detected radar target based on the result of the examination. Correlating the measurement vector with control vectors associated with different angles can comprise multiplying the measurement vector by the control vectors associated with the different angles, the result of which is an angular spectrum associated with the detected radar target. For example, the control matrix can be multiplied by the measurement vector. In the simplest case, the angle can be estimated by searching for the maximum in the particular angular spectrum. For correlation, what are known as DML functions (deterministic maximum likelihood functions) can be formed, which indicate how strongly the amplitude and phase relationships actually measured for a radar target correlate with the control vectors, i.e., the theoretical amplitude and phase relationships for different angle hypotheses. An angle hypothesis for which the correlation is largest then represents the best estimated value for the angle of the object. For a uniform bistatic virtual array, computationally efficient methods such as an FFT or the matrix pencil method can be used.

According to an example embodiment of the present invention, determining the estimated angle based at least on a product of the measurement vector with a control vector can in particular be carried out based on a product of the measurement vector with a control vector from a set of control vectors that are associated with different angles. By determining the estimated angle based at least on a product of the measurement vector with a control vector, the phase information of the individual components of the measurement vector is also included in the estimation of the angle, taking into account the control vector. Determining the estimated angle based at least on a product of the measurement vector with a control vector can in particular comprise: determining the estimated angle based at least on a product of the measurement vector with a control vector associated with an angle corresponding to an angle hypothesis. The angle hypothesis can in particular be determined based on a correlation of a measurement vector of at least one individual radar sensor, which measurement vector is associated with the detected radar target, with control vectors of the individual radar sensor, which control vectors are associated with different angles. That is to say, starting from an angle hypothesis as a result of correlating or estimating the angle of an individual radar sensor (with a measurement vector comprising, for example, only monostatic components), the phase information of the measurement vector comprising bistatic components can be evaluated in order to obtain an angle estimation taking bistatic channels into account. However, the angle hypothesis can also be determined, for example, based on a correlation of a measurement vector of at least one bistatic virtual sensor, which measurement vector is associated with the detected radar target, with control vectors of the bistatic virtual sensor, which control vectors are associated with different angles, for example in a manner referred to here as “first correlation.”

The bistatic components of the measurement vector, which correspond to a product of respective measured values of bistatic channels of the radar sensor network, are hereinafter also referred to as bistatic product components or channel product components, and the product is hereinafter also referred to as the channel product.

In an advantageous example embodiment of the present invention, the method according to a second aspect furthermore comprises: preparing the cooperative radar sensor network for bistatic angle estimations according to the method according to the first aspect.

In particular, when correlating a measurement vector associated with a detected radar target with control vectors associated with different angles, the control vectors can be associated with the respective angles by the determined association. In particular, the angle of the detected radar target can be estimated based on the determined association.

At least one of the above objects may be achieved according to a third aspect of the present invention by a method for a cooperative radar sensor network having a plurality of individual radar sensors, for preparing the cooperative radar sensor network for bistatic angle estimations. According to an example embodiment of the present invention, the method comprises: determining an association that associates a particular control vector with each of a plurality of angles, wherein the particular control vector has at least bistatic components, wherein a bistatic 1-th component of the control vector corresponds to a product of: a particular first component of a transmission control vector of a particular first of the radar sensors, wherein the first component corresponds to an m-th transmission antenna element of the first radar sensor; and a particular second component of a reception control vector of a particular second of the radar sensors, wherein the second component corresponds to an n-th reception antenna element of the second radar sensor.

According to the third aspect of the present invention, bistatic components of the control vector that correspond not to a channel product of two bistatic channels but to a product of components of transmission control vectors and reception control vectors are thus used. The transmission control vectors are one-way control vectors that indicate properties of the transmission antenna radiation pattern of the particular transmission antenna element. The reception control vectors are one-way control vectors that indicate properties of the reception antenna radiation pattern of the particular reception antenna element. Otherwise, the method according to the third aspect corresponds to the method according to the first aspect. The following explanations complement the above explanations of the first aspect, which are not repeated here.

The association that associates a particular control vector with each of a plurality of angles can in turn, for example, be a control matrix and can also be called a calibration matrix or antenna radiation pattern.

The l-th component of the aforementioned bistatic control vectors is a bistatic component. It corresponds to a product of the particular first component of a transmission control vector of the particular radar sensor and the particular second component of a reception control vector of the particular second radar sensor. In particular, it can be the product. The product comprises at least an addition of the relevant phases of the respective components of the transmission control vector under consideration and the reception control vector under consideration.

For preparing the cooperative radar sensor network for bistatic angle estimations, the respective calibration values of the paths associated with the transmission antenna elements and the reception antenna elements of the respective radar sensors can thus be combined.

In particular, the bistatic l-th component of the control vector can correspond to a product of: a particular first measured component (in particular: a component determined in a calibration measurement) of a transmission control vector of a particular first of the radar sensors, wherein the first component corresponds to an m-th transmission antenna element of the first radar sensor; and a particular second measured component (in particular: a component determined in a calibration measurement) of a reception control vector of a particular second of the radar sensors, wherein the second component corresponds to an n-th reception antenna element of the second radar sensor.

According to an example embodiment of the present invention, when calibrating the respective transmission antenna elements (TX calibration) of a particular individual sensor, the signals or electromagnetic waves emitted by the respective transmission antenna elements (TX antennas) can, for example, be received at different angles by an antenna (TRX antenna) of a calibration receiver synchronized with the individual sensor. A complex amplitude and, in particular, phase value can be determined for all channels associated with the respective paths from the transmission antenna elements to the calibration antenna (or to the calibration receiver). When calibrating the respective reception antenna elements (RX calibration), a signal synchronized with the individual sensor (i.e., a wave that is phase-coherent with the individual sensor) can be emitted from the same calibration antenna (TRX antenna), which signal is then received and detected by the reception antenna elements (i.e., by all RX channels). Here, too, the complex reception values are determined for all reception antenna elements. Once the individual sensors have been calibrated, the transmission and reception phases of all individual sensors are available, and the two-way calibration values for all monostatic and bistatic virtual channels can be determined mathematically.

The method of the present invention may have the advantage that, by combining the respective components (or calibration values) of the transmission control vectors and reception control vectors for the particular transmission antenna and reception antenna, in particular a particular phase value for the bistatic components of the control vector can be determined. The bistatic channels can thus be calibrated without the need for complex measurement of the bistatic components of the installed radar sensor network. Transmission control vectors or transmission calibration matrices or transmission antenna radiation patterns as well as reception control vectors or reception calibration matrices or reception antenna radiation patterns of the individual radar sensors associated with respective angles can be determined by one-way calibration measurements of the individual radar sensors. They can be measured for each individual radar sensor at the factory before the radar sensor network is installed. That is to say, if the factory calibration is split into RX and TX paths, the phase values for each transmission or reception antenna are available individually, i.e., not as a two-way measurement. The association can be determined, for example, before the radar sensor network is put into practical use, for example after the cooperative radar sensor network has been installed.

Determining the association thus makes it possible to allow an angle evaluation of the bistatic paths of the cooperative radar sensor network or to prepare the cooperative radar sensor network for bistatic angle estimations without measuring a calibration matrix of the bistatic paths or of the entire radar sensor network. Control vectors having bistatic components can be calculated and the association can be determined without the need for very complex and costly measurement of the bistatic components of the installed radar sensor network or of the overall system (if this is even possible). The calibration effort can thus be significantly reduced. By also using the bistatic paths for angle evaluation, a much larger virtual antenna aperture can be spanned. A calibration matrix for the full antenna aperture can thus be determined by separate RX and TX calibration of the individual sensors and their combination for monostatic and bistatic paths. A calibration of the entire cooperative system can be derived based on a monostatic calibration of the individual sensors used.

At least one of the aforementioned objects is achieved according to a fourth aspect of the present invention by a method for a cooperative radar sensor network having a plurality of individual radar sensors, for estimating an angle of a radar target, wherein the method comprises: preparing the cooperative radar sensor network for bistatic angle estimations according to the method according to the third aspect, determining a measurement vector associated with a detected radar target, wherein the measurement vector has at least bistatic components, wherein a bistatic l-th component of the measurement vector corresponds to a measured value of a bistatic channel, which measurement vector is associated with the radar target and which bistatic channel corresponds to an m-th transmission antenna element of a particular first of the radar sensors and an n-th reception antenna element of a particular second of the radar sensors, and estimating the angle of the detected radar target, wherein the estimated angle is determined based on a result of correlating the measurement vector with control vectors associated with different angles or based at least on a product of the measurement vector with a control vector.

In particular, when correlating a measurement vector associated with a detected radar target with control vectors associated with the different angles, the control vectors can be associated with the respective angles by the determined association. In particular, the angle of the detected radar target can be estimated based on the determined association.

According to the fourth aspect of the present invention, a measurement vector having bistatic components that correspond not to a channel product of two bistatic channels but only to one bistatic channel of the radar sensor network is used. Otherwise, the method according to the fourth aspect corresponds to the method according to the second aspect.

The angle is in particular estimated in the practical use of the radar sensor network. The following explanations complement the above explanations of the first, second, third and fourth aspects, which are not repeated here.

Advantageous developments and example embodiments of the present invention are disclosed herein. Advantageous features, developments and example embodiments of the present invention are also described below. They can each be used in the method according to any of the aspects described herein.

According to an example embodiment of the present invention, the method can comprise: storing the association that associates the particular control vector with each of a plurality of angles. The association can, for example, be stored at the factory before the cooperative radar sensor network is put into operation.

The method can in particular be a method for a cooperative radar sensor network for vehicles, in particular motor vehicles.

The methods described above allow or carry out a “monostatic evaluation” of the bistatic virtual sensor. That is to say, the bistatic reflections can now additionally be evaluated, but the angle of a detection cannot yet be evaluated on the finer, coherently cooperative angle grid based on the total antenna aperture consisting of actual physical sensors and bistatic sensors. For this purpose, the virtual sensors must be spatially located between the physically existing sensors and the existing physical sensors must be spatially located relative to one another, thus determining the relative phase relationships between the subapertures.

In an advantageous example embodiment of the present invention, the method comprises: a first correlation of a first measurement vector of at least one bistatic virtual sensor, which first measurement vector is associated with the detected radar target, with control vectors of the bistatic virtual sensor, which control vectors are associated with different angles, wherein the bistatic virtual sensor corresponds to a configuration of bistatic channels of the particular first radar sensor and the particular second radar sensor, wherein the measurement vector of the bistatic virtual sensor has the bistatic components; and/or a second correlation of a second measurement vector of at least one individual radar sensor, which measurement vector is associated with the detected radar target, with control vectors of the individual radar sensor, which control vectors are associated with different angles, wherein estimating the angle of the detected radar target comprises: determining a phase vector that associates respective phases with the at least one bistatic virtual sensor and the at least one individual radar sensor, each of which phases is obtained based at least on the result of at least one of the first correlation and the second correlation; a third correlation of the determined phase vector with phase vectors that are associated with different angles and indicate phase relationships between the at least one individual radar sensor and the at least one bistatic virtual sensor due to their mutual spatial offsets; determining an ambiguous estimated value for the angle of the radar target based on the result of the third correlation; and resolving the ambiguity of the estimated value for the angle of the radar target based on a result of the first or the second correlation.

The aforementioned correlation, based on the result of which the estimated angle is determined, can comprise or be the first correlation.

According to an example embodiment of the present invention, the phase vector associates respective phases with the at least one bistatic virtual sensor and the at least one individual radar sensor, each of which phases is obtained based at least on the result of at least one of the first correlation and the second correlation. In particular, in embodiments, the respective phases are obtained based on a product of a measurement vector of the at least one individual radar sensor or the at least one bistatic virtual sensor with a corresponding control vector associated with an angle corresponding to an angle hypothesis, wherein the angle hypothesis is obtained based on the result of at least one of the first correlation and the second correlation. In particular, a particular component of the phase vector can correspond to a product of the measurement vector of the particular real or virtual sensor with the control vector associated based on an angle hypothesis, wherein the angle hypothesis is determined based on the result of the relevant correlation. In this case, respective angle hypotheses for the particular virtual or real radar sensor can be determined based on the result of the particular first or second correlation, or an angle hypothesis can be determined based on one of the first or second correlations; in the latter case, a same angle hypothesis can thus be used for a plurality of real or virtual sensors, and the control vector of the relevant real or virtual sensor associated based on the angle hypothesis is used in each case.

According to an example embodiment of the present invention, the method can comprise: determining an angle hypothesis based on the result of the first correlation, or determining an angle hypothesis based on the result of the second correlation.

In example embodiments of the present invention, the method comprises the first correlation and the second correlation, and the phase vector associates the respective phases obtained based on the result of the particular first and second correlations. In particular, the phase vector associates a phase with the particular bistatic virtual sensor, which phase is obtained based on the result of the relevant first correlation, and the phase vector associates a phase with the particular individual radar sensor, which phase is obtained based on the result of the particular second correlation.

In other example embodiments of the present invention, the method comprises the first correlation or the second correlation, and the phase vector associates the respective phases, each of which is obtained based on the result of the first correlation, or the phase vector associates the respective phases, each of which is obtained based on the result of the second correlation. For example, an angle hypothesis can be determined based on the result of the first or second correlation, and the phases that the phase vector associates with the at least one bistatic virtual sensor and the at least one individual radar sensor are obtained based on this angle hypothesis. The first correlation or the second correlation can be part of a corresponding angle estimation for the detected radar target and the relevant bistatic virtual sensor or individual radar sensor.

The first correlation and/or the second correlation can comprise calculating an angular spectrum associated with the detected radar target. The angle hypothesis can correspond to an angle at which the angular spectrum reaches a maximum absolute value. The phase associated with the relevant sensor can correspond to a phase of a particular complex value of the maximum of the absolute value of the relevant angular spectrum. The phase vector can be a vector whose components correspond to the phase values determined from the respective maxima of the angular spectra.

The phase vectors associated with the different angles can be calculated from known positions or from determined positions of the real and virtual sensors relative to one another, as specified below. These relative positions are also referred to as mutual spatial offsets between the respective sensors.

A position vector can be created from the positions of the real and virtual sensors relative to one another, the components of which position vector can be understood as installation positions of the respective sensors in question. The installation positions of the respective sensors may have been determined by measurement and/or mathematically. A position estimation matrix can be generated from the position vector using geometric relationships between the relevant sensors. The position estimation matrix can have the following form, where d is the position vector and α is a particular angle of a radar target and λ is the radar wavelength:

$$P ( α , d ) = {e}^{\frac{j 2 π d}{λ} sin ( α )}$$

For the calculation of the position vector, in particular the position estimation matrix, any reference position on the particular sensor can be used as a reference point for the particular sensor in the case of antenna arrays of the radar sensors with a similar structure. For example, a particular center of gravity, in particular a particular phase center of gravity of a reference channel, a particular edge of the sensor for a particular specific antenna element of the sensors can be selected.

The rows of the position estimation matrix thus correspond to phase vectors which are associated with different angles and each of which indicates an angle-dependent phase relationship between the respective radar sensors due to their mutual spatial offsets. The measurement results for the physical and virtual sensors or subapertures are interpolated using the position vectors to the increased accuracy of the total aperture.

The third correlation can comprise determining an angular spectrum (spectrum of the position vector) by multiplying the phase vector by the position estimation matrix. Since only the positions of the sensors are considered for the third correlation and the relative distances of the positions of the sensors (or distances of the subapertures) can be a multiple of the wavelength of the received signals, this angular spectrum can be ambiguous. These distances can be several 10λ or larger. The ambiguity is characterized by the fact that, for a plurality of angles, in particular for a periodic angle, a value that has the same amplitude and corresponds to the detected radar target occurs. Since only the position and no sensor characteristics are considered here, this spectrum is not weighted by the envelope of the individual sensors. It follows that the amplitude values of all possible angles are identical.

Resolving the ambiguity means selecting an estimated value among the ambiguous estimated values for the angle of the radar target. In order to evaluate the two spectra of the individual sensor and of the position vector together, a region around the peak can be selected in the individual spectrum and overlaid with the same region in the position vector spectrum. It is important that only a single “needle” of the position spectrum comes to lie in the region to be evaluated. The position of the needle of the position vector spectrum is used to select the angle in the individual sensor spectrum that corresponds to the best estimation of the angle with the accuracy of the total aperture. The resolution is carried out based on the results of the first and/or the second correlation, in particular based on an angular spectrum that comprises at least one neighborhood around a maximum (relative to the absolute value) of the angular spectrum. The neighborhood is chosen such that one (exactly one) estimated value of the ambiguous estimated value falls within the neighborhood. In other words, by multiplying the results of the first and/or second correlation by the result of the third correlation, an angular refinement of the results of the first and/or the second correlation can be carried out, whereby the angle at which a radar target is detected can be determined with refined angular resolution.

The spectrum of an individual sensor angle estimation (virtual, bistatic or physical) and the ambiguous spectrum of the position vector of the virtual sensors can thus be used. In particular, for example, the particular real or virtual radar sensor can have an angular resolution that is limited by the aperture of the relevant sensor; by evaluating the phase vector using the phase vectors associated with the individual angles, phase information from the larger aperture of the cooperative radar sensor network can be evaluated and the angular resolution can be refined.

The method of the present invention is particularly computationally efficient and allows a cost-efficient implementation of the angle estimation over the entire cooperative antenna aperture, since, for example, an evaluation of an angular spectrum for a limited angle range and/or an individual radar sensor or virtual sensor is sufficient and a high angular resolution is still achieved by the third correlation. In particular, an angle evaluation can be carried out at full aperture without having an explicit calibration matrix or control matrix for the full aperture. Control vectors having bistatic components can be calculated and the association can be determined without the need for very complex and costly measurement of the bistatic components of the installed radar sensor network or of the overall system (if this is even possible). The calibration effort can thus be significantly reduced.

According to an example embodiment of the present invention, the method comprises determining the phase vector. In particular, the phases can each correspond to a product of a particular measurement vector of the individual radar sensor or bistatic virtual sensor, which measurement vector is associated with the detected radar target, with a particular control vector that is associated with an angle corresponding to a particular angle hypothesis, wherein the particular angle hypothesis is obtained based on the respective results of the first correlation and/or of the second correlation.

Knowing the exact spatial position of the virtual bistatic sensors and of the virtual channels in space, an angle estimation based on the entire cooperative radar network is thus made possible.

The described method of the present invention, in which a phase vector is determined and the third correlation is carried out, also represents an invention independently of the first to fourth aspects. According to a fifth aspect of the disclosure, a method is therefore provided for a cooperative radar sensor network having a plurality of individual radar sensors, for estimating an angle of a radar target, wherein the method comprises: determining a measurement vector associated with a detected radar target, wherein the measurement vector has at least bistatic components, and estimating the angle of the detected radar target, wherein the estimated angle is determined based on a result of a correlation of the measurement vector with control vectors associated with different angles or based at least on a product of the measurement vector with a control vector, wherein the method comprises: a first correlation of a first measurement vector of at least one bistatic virtual sensor, which first measurement vector is associated with the detected radar target, with control vectors of the bistatic virtual sensor, which control vectors are associated with different angles, wherein the bistatic virtual sensor corresponds to a configuration of bistatic channels of a particular first radar sensor and a particular second radar sensor, wherein the measurement vector of the bistatic virtual sensor has the bistatic components; and/or a second correlation of a second measurement vector of at least one individual radar sensor, which second measurement vector is associated with the detected radar target, with control vectors of the individual radar sensor, which control vectors are associated with different angles, wherein estimating the angle of the detected radar target comprises: determining a phase vector that associates respective phases with the at least one bistatic virtual sensor and the at least one individual radar sensor, each of which phases is obtained based at least on the result of at least one of the first correlation and the second correlation; a third correlation of the determined phase vector with phase vectors that are associated with different angles and indicate phase relationships between the at least one individual radar sensor and the at least one bistatic virtual sensor due to their mutual spatial offsets; determining an ambiguous estimated value for the angle of the radar target based on the result of the third correlation; and resolving the ambiguity of the estimated value for the angle of the radar target based on a result of the first or the second correlation. The method according to the fifth aspect can be used with the methods of the first to fourth aspects.

In the example embodiments of the present invention just described, an evaluation of a measurement vector of a bistatic virtual sensor or a real radar sensor is carried out with a corresponding control vector. In other embodiments, a measurement vector or a corresponding control vector that comprises both monostatic and bistatic components can be used.

In particular, according to the first, second, third or fourth aspect of the present invention, the particular control vector associated with an angle can be composed of monostatic components and the bistatic components, wherein a particular monostatic component is a component of a control vector of a relevant one of the radar sensors.

A control vector associated with an angle, in particular a particular row of a control matrix associated with an angle, can comprise monostatic components and bistatic components. In other words, a particular control vector can comprise components in each case associated with monostatic paths of the relevant radar sensors and components in each case associated with bistatic paths of the relevant radar sensors. The angle grid can correspond to the calibration steps of the individual sensor.

The method may have the advantage that a calibration matrix or control matrix for the full virtual aperture can be determined without measuring the full aperture or measuring the bistatic channels. The calibration matrix for the full antenna aperture can be determined mathematically based on a two-way calibration of the individual sensors. In particular, the calibration matrix for the total aperture can be determined based on the position of the virtual and physical sensors as well as the calibration matrices (association of the control vectors) of the physical and virtual bistatic sensors. The calibration matrix for the full antenna aperture can also be determined based on an ideal calculated calibration matrix, and correction factors can be determined by online calibration methods. The calibration matrix is determined using the angular granularity of the individual sensor calibration.

According to the first or second aspect of the present invention, the components associated with bistatic paths can, for example, be product components that correspond to combinations, in particular of redundant bistatic paths of the channels associated with the relevant radar sensors.

In example embodiments of the present invention, the method furthermore comprises: correcting the phases of the components of the particular control vector based on a particular phase correction that corresponds to a particular phase shift resulting for the particular angle from the mutual spatial offset between the respective sensors of the at least one individual radar sensor and at least one bistatic virtual sensor, wherein the bistatic virtual sensor corresponds to a configuration of bistatic channels of a particular first radar sensor and a particular second radar sensor. Phase progressions due to the positioning of the sensors/virtual sensors are thus corrected at the corresponding positions of the control vectors or the control matrix.

The phase corrections can be determined and/or used as associations of angles with phase correction vectors or as phase correction matrices.

Knowing the exact spatial position of the virtual bistatic sensors and of the virtual channels in space, an angle estimation based on the entire cooperative radar network is thus made possible. In particular, a (corrected) calibration matrix for the total aperture can be created.

The phase shifts can be determined for the particular angle in particular by phase relationships between two (real and/or virtual) sensors, in particular by phase relationships between the at least one individual radar sensor and the at least one bistatic virtual sensor, due to their mutual spatial offsets. In particular, for a sensor, the respective phase corrections of the components of a control vector of the sensor, which control vector is associated with an angle, can be identical, i.e., all components of the control vector of the sensor are corrected with a same phase correction that depends on the angle and on the sensor.

A particular phase correction can comprise respective phase correction values of the form e^{-j·2·π·k} derived from a geometric relationship, in particular from a particular spatial offset between the relevant sensors, where k is an integer. The correction factors can be determined by online calibration or field calibration methods.

The respective phase corrections can be determined based on a measurement of a detected radar target. The measurement is also called a spot measurement. In particular, a relationship between the angle and the phase position can be established for a single spot measurement and can analytically be transferred to all other angles using trigonometry and knowledge of the sensor offsets. This makes it possible to correct phase offsets between individual radar sensors, for example including phase offsets caused by cable lengths. Alternatively, the phase corrections or the phase correction vectors or phase correction matrices can be calculated purely analytically by knowing the position of the virtual channels on the total aperture (or the exact position of the virtual or physical sensors).

In the case of a bistatic product component of the control vector, the phase shift can be twice a phase difference resulting from the run length difference due to the geometry for an angle.

In example embodiments of the present invention according to any of the first to fifth aspects comprising the step of the third correlation of the phase vector, as well as in embodiments according to any of the first to fourth aspects comprising correcting the phases of the components of the particular control vector, the mutual spatial offsets between two respective sensors can be determined as indicated below. In particular, the individual radar sensors can be precisely located relative to one another, and the virtual bistatic sensor can thus be precisely located relative to an individual radar sensor.

In example embodiments of the present invention, the method furthermore comprises: determining the mutual spatial offsets between two respective sensors of sensors comprising the plurality of individual radar sensors and the at least one bistatic virtual sensor, based on signals of the two sensors from a plurality of detected radar targets each associated with different angles, wherein determining comprises: examining correlations of phases (in particular: measured phases) of the signals associated with the particular radar target (in particular: signals at the spatial positions of the virtual antenna elements) of one of the two respective sensors with an extrapolated spatial phase characteristic of the signals of the other of the two respective sensors, which signals are associated with the radar target; and determining the mutual spatial offset between the two respective sensors based on the results of the examination, for example based on a highest correlation quality across the plurality of detected radar targets and a plurality of offset hypotheses or correlation positions. In embodiments, the two respective sensors comprise two of the plurality of individual radar sensors. In embodiments, the two respective sensors comprise one of the individual radar sensors and one of the at least one bistatic virtual sensor.

According to an example embodiments of the present invention, the method can furthermore comprise: determining mutual spatial offsets between two respective sensors comprising a bistatic virtual sensor and one of two respective individual radar sensors, based on the determined mutual spatial offsets between the two individual radar sensors. This can be done mathematically. The bistatic virtual sensor comprises at least one bistatic channel that is associated with the two individual radar sensors. In other words, the bistatic virtual sensor corresponds to at least one bistatic channel (or bistatic channels) of the two individual sensors. Once the positions of the real sensors have been determined relative to one another, the position of the corresponding virtual sensor can thus be accurately calculated therefrom.

Thus, for each of the plurality of detected radar targets (test targets) associated with different angles, it is examined how strongly phases of the signals of a sensor (for example at a particular virtual antenna position), which signals are associated with the particular radar target, correlate with an extrapolated spatial phase characteristic of the signals of the other radar sensor associated with the same radar target. Based on the results of the examination, an offset can be determined at which the extrapolated spatial phase characteristics maximally match the measured phases.

In particular, the extrapolated spatial phase characteristic is a spatial phase characteristic extrapolated beyond the extent of the sensor or its real or virtual antenna array. The phase characteristic can be extrapolated periodically, in particular sinusoidally or generally as a harmonic oscillation. The extrapolation takes advantage of the fact that the phase characteristic across the sensor can be determined without ambiguity by using a plurality of virtual antenna positions or reception antenna elements, for example of the relevant physical sensor, in particular if at least one distance between two virtual antenna elements is less than or equal to λ/2. This is the case for all sensors where at least one distance between at least two of the virtual antenna elements is designed to be λ/2. This is typically the case on all common radar sensors. Under this condition, the phase can be spatially “unrolled” beyond the individual sensor for different test angles, i.e., can be extrapolated as a harmonic oscillation, in particular up to a reference point, for example of the bistatic virtual sensor with a known phase. Since this spatial phase progression depends on the angle, this process must be repeated for different test angles. The phase at the reference point is known from the measurement. On the spatially unrolled phases, the spatial positions at which the phase corresponds to the desired phase at the reference point can now be determined. This creates a plurality of hypotheses for the position of the reference point for the different test angles. The point in the spatially unrolled phase at which most or all hypotheses for the test angles/test targets match is accordingly used as the reference point or position hypothesis for determining the offset.

By extrapolating the spatial phase characteristic from two sides, for example from a first sensor toward a second sensor and from the second sensor toward the first sensor, the confidence of the selected position hypothesis can be further increased, or the hypothesis formulated from one side can be validated from the other side.

A phase of a signal received by the respective sensors can each be associated with the two respective sensors. The phase corresponds to a particular component of a measurement vector associated with the detected radar target. A phase characteristic across the channels, or transmission or reception antenna elements, can in each case be associated with signals associated with the relevant sensors. The position of a channel can be assumed to be the phase center of gravity of the particular channel (of the respective transmission and reception antenna elements).

The relevant sensors can each receive a plurality of signals, each of which is associated with a radar target associated with a different angle.

The extrapolated spatial phase progressions of the signals received by each of the respective sensors, each of which is associated with a particular radar target at a different angle, can be different. In particular, a particular extrapolated spatial phase characteristic can be angle-dependent.

The phase characteristic of the signals of the other of the two sensors, which signals are associated with the radar target, can result from a particular measurement vector whose components are associated with respective spatial positions (relative to the sensor). The spatial positions can correspond to phase centers of gravity of the relevant channel or channel product.

The phases and phase characteristics can be determined for respective bistatic channels from signals that correspond to respective measured values of a bistatic channel or to respective products of measured values of bistatic channels, corresponding to respective product components of a measurement vector.

Each extrapolated spatial phase characteristic of the signals of the other of the two sensors, which signals are associated with a radar target, can match the phase of the signal associated with the detected radar target, which phase is measured by one of the two sensors, at periodic locations. The period depends on the angle of the radar target.

Examining the correlations can comprise examining matches and/or similarities between the signals received by one of the two respective sensors, in particular their phases, and the extrapolated spatial phase characteristics of the other of the two respective sensors.

Correlations can be examined in particular for signals from a plurality of channels of one of the two sensors, which signals are associated with the particular radar target. This allows a plurality of signals to be examined with regard to their correlation with the extrapolated phase characteristics.

According to an example embodiment of the present invention, examining the correlations can in particular comprise: examining correlations of spatial phase characteristics of the signals of one of the two respective sensors, which signals are associated with the particular radar target, with an extrapolated spatial phase characteristic of the signals of the other of the two respective sensors, which signals are associated with the radar target. Thus, for the particular radar target, a correlation between a measured phase characteristic of the one sensor and an extrapolated phase characteristic of the other sensor is examined.

The phase characteristic of the signals of the one of the two sensors, which signals are associated with the radar target, can also result from a particular measurement vector whose components are associated with respective spatial positions (relative to the sensor). The spatial positions can correspond to phase centers of gravity of the relevant channel or channel product.

Based on the results of the examination, a mutual spatial offset between the two respective sensors can be determined. In particular, the mutual spatial offset between the two respective sensors can be determined based on a result associated with the convolution operation. For example, by determining a maximum value of the result of the convolution operation (or the plurality of convolution operations for the respective radar targets or their angles), the mutual spatial offset between the two respective sensors can be determined.

The position of the virtual antenna elements or channels of a bistatic virtual sensor can, for example, be determined more precisely based on roughly known positions of the channels by resolving ambiguities for the run lengths of the signals due to possible phase jumps of k·2·π based on a monostatic angle estimation of an individual sensor and based on phases of the complex measured variables of the virtual channels. Such ambiguities can arise, for example, from larger distances between the virtual channels. The position of the virtual antenna elements or channels of a bistatic virtual sensor can also be determined, for example, by TDM (time division multiplexing) MIMO calculation and knowledge of the exact position of the TX and RX antennas on the physical sensors.

The method according to the various aspects of the present invention can comprise: increasing the angular resolution of the association of the control vectors with the angles by interpolating the control vectors. Thus, intermediate angle steps can be refined by interpolation. This allows the angular granularity of the association or of the bistatic calibration matrix to be improved compared to the monostatic angular accuracy. This is made possible by the larger total aperture compared to the individual sensor and the phase-correct inclusion of measured values of the bistatic channels.

In example embodiments of the present invention, the method furthermore comprises: refining, by interpolation, the angular granularity of the association that associates a particular control vector with each of a plurality of angles. That is to say, the control vectors or the control matrix are interpolated. In particular, this results in an increase (improvement) in the angular resolution of the value range for the angle. This can be done in particular in the first or third aspect, but also in the association of the control vectors according to the second or fourth aspect.

In example embodiments of the present invention, in the estimation of the angle of the detected radar target, the angle is estimated with an angular granularity of less than or equal to 0.5°, preferably less than or equal to 0.1°. In particular, in the third correlation, the angular granularity of the association of the phase vectors with the different angles can be less than or equal to 0.5°, preferably less than or equal to 0.1°. In particular, in each of the first to fifth aspects, the association of the control vectors with different angles can have the aforementioned angular granularity.

In example embodiments of the present invention, the association of the different angles with the phase vectors has a smaller angular granularity in the third correlation than the association of the control vectors of the bistatic virtual sensor with the different angles in the first correlation and/or than the association of the control vectors of the individual radar sensor with the different angles in the second correlation.

These aforementioned example embodiments of the present invention with improved or smaller angular granularity have the particular advantage that angle estimation with particularly high angular resolution is made possible without the entire control matrix having to be measured with this angular resolution. In particular, the control matrix does not need to be determined by calibration measurements of the system with the high angular resolution.

The present invention also relates to a cooperative radar sensor network, in particular for vehicles or motor vehicles, in which one of the methods described above is implemented. According to a further aspect of the disclosure, a cooperative radar sensor network having a plurality of individual radar sensors is therefore provided, comprising a control and evaluation device that is configured to perform a method according to one of the example embodiments disclosed herein. The control and evaluation device can, for example, be connected to the radar sensors.

Preferred exemplary embodiments of the present invention are explained in more detail below with reference to highly simplified schematic figures.

### BRIEF DESCRIPTION OF THE DRAWINGS

FIG. 1 is a schematic representation of a first example embodiment of a method for a cooperative radar sensor network having a plurality of individual radar sensors, for estimating an angle of a radar target, according to the present invention.

FIG. 2 is a schematic representation of a second example embodiment of the method and the cooperative radar sensor network, according to the present invention.

FIGS. 3A and 3B are schematic representations of details of the method of the first or second embodiment relating to determining an association that associates a particular control vector with each of a plurality of angles, according to the present invention.

FIGS. 4A and 4B are schematic representations of details of the method of the first or second embodiment relating to determining a mutual spatial offset between respective sensors, according to the present invention.

FIG. 5A-5D are schematic representations of details of the second embodiment of the method relating to the angle estimation, according to the present invention.

In the following description of exemplary embodiments of the present invention, the same or similar reference signs are used for the elements shown in the various figures and acting similarly, wherein a repeated description of these elements is dispensed with.

### DETAILED DESCRIPTION OF EXAMPLE EMBODIMENTS

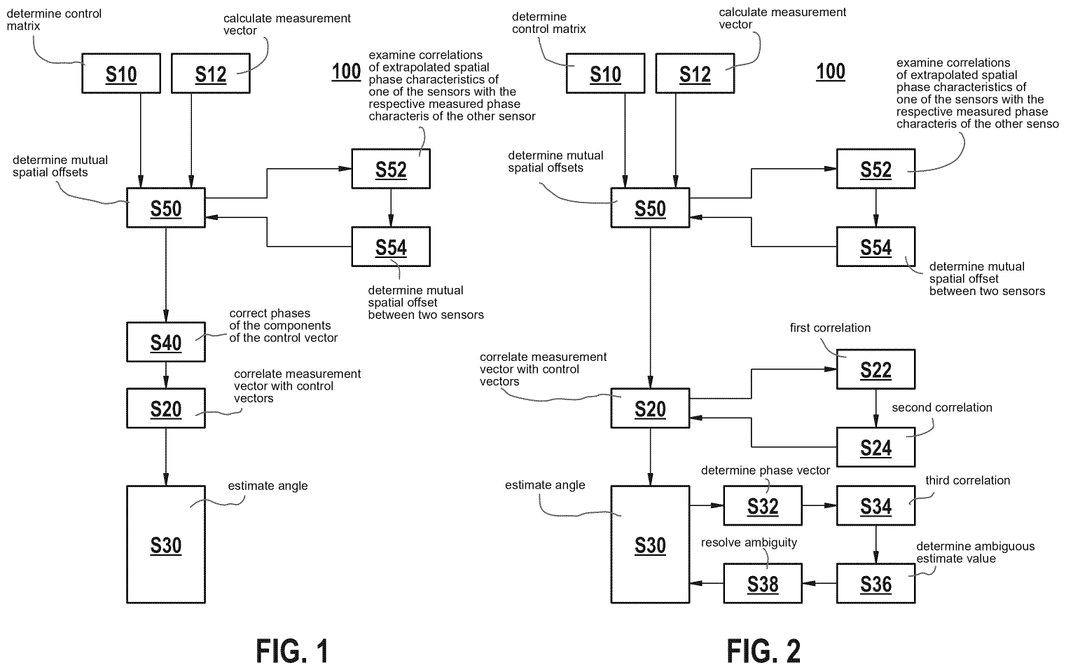

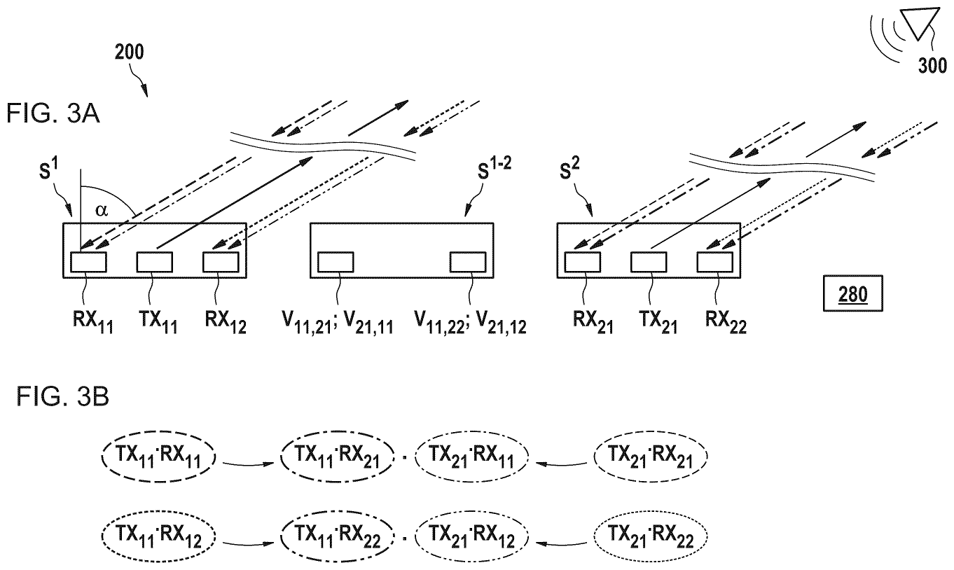

FIG. 1 is a schematic representation of a first embodiment of the method 100 for a phase-coherent cooperative radar sensor network 200 (FIG. 3A) having a plurality of individual radar sensors S¹, S², for estimating S30 an angle α of a radar target 300. For simplifying the representation, the radar sensor network 200, as shown schematically in FIG. 3A, comprises two individual radar sensors S¹, S², each of which has a transmission antenna element TX₁₁, TX₂₁ and two reception antenna elements RX₁₁, RX₁₂, RX₂₁, RX₂₂. The first number in the index refers to the particular number of the individual radar sensors S¹, S² and the second number refers to the particular number of the corresponding reception or transmission antenna element. In practice, a plurality of transmitting and more than two reception antenna elements can be provided per radar sensor, and more than two radar sensors can be provided. The transmission antenna elements TX₁₁, TX₂₁ and the reception antenna elements RX₁₁, RX₁₂, RX₂₁, RX₂₂ are arranged in different positions on the respective radar sensors S¹, S² in a direction in which the particular radar sensor S¹, S² or the cooperative radar sensor network 200 is angle-resolving. Radar signal paths, in particular respective channels, are associated with a particular combination of a transmission antenna element TX₁₁, TX₂₁ and a reception antenna element RX₁₁, RX₁₂, RX₂₁, RX₂₂ depending on the radar sensors S¹, S² involved. As shown in FIG. 3B, respective monostatic channels TX₁₁·RX₁₁, TX₁₁·RX₁₂, TX₂₁·RX₂₁, TX₂₁·RX₂₂ according to the first or second aspect of the present invention correspond to monostatic radar signal paths in which the transmission antenna element TX₁₁, TX₂₁ and the reception antenna element RX₁₁, RX₁₂, RX₂₁, RX₂₂ belong to the same radar sensor S¹, S² of the radar sensor network 200. For preparing the cooperative radar sensor network 200 for bistatic angle estimations, in step S10, an association that associates a particular control vector A_{α} with each of a plurality of angles α (azimuth angles) at which a particular radar target 300 can be detected is determined. In other words, determining S10 the association is determining a control matrix A. The control matrix A has y rows, in particular control vectors A_{α}, where y is a natural number corresponding to the number of the plurality of angles α. Each of the y rows is associated with a different angle α. A particular control vector A_{α} of the control matrix A comprises x components A_{αx}, where x is a natural number. An l-th component of the particular control vector A_{α} is a bistatic component A¹⁻²_{α1}, where A¹⁻²_{α} is a subvector of A_{α} that summarizes the bistatic components. It corresponds to a complex product TX₁₁·RX₁₁·TX₂₁·RX₂₁, TX₁₁·RX₁₂·TX₂₁·RX₂₂ of a particular first monostatic component TX₁₁·RX₁₁, TX₁₁·RX₁₂ of a control vector of the particular first radar sensor S¹ and a particular second monostatic component TX₂₁·RX₂₁, TX₁₁·RX₂₂ of a control vector of the particular second radar sensor S². The association S10 is determined without measuring the bistatic components of the installed radar sensor network 200 and before the radar sensor network 200 is put into practical use or after the cooperative radar sensor network 200 has been installed. The particular control vector A_{α} also has, in addition to the bistatic components of the subvector A¹⁻²_{α}, monostatic components of subvectors A¹_{α}, A²_{α} that correspond to respective monostatic components TX₁₁·RX₁₁, TX₁₁·RX₁₂, TX₂₁·RX₂₁, TX₂₁·RX₂₂ of control vectors of the individual radar sensors S¹, S². A product TX₁₁·RX₂₁·TX₂₁·RX₁₁ Or TX₁₁·RX₂₂·TX₂₁·RX₁₂ of respective bistatic channels V_{11,21}; V_{21,11} or V_{11,22}; V_{21,12} of a virtual sensor S¹⁻² is associated with the particular bistatic l-th component A¹⁻²_{α1} of the control vector A. In this case, the index contains the numbers of the transmitting and (after the decimal point) receiving radar sensor S¹, S² and the number of the corresponding reception or transmission antenna element for the particular radar sensor. Due to redundancy of the bistatic channels V_{11,21}; V_{21,11}; V_{11,22}; V_{21,12} of the virtual sensor S¹⁻², the following applies in general:

$${TX}_{1 m} \cdot {RX}_{1 n} \cdot {TX}_{2 m} \cdot {RX}_{2 n} = {TX}_{1 m} \cdot {RX}_{2 n} \cdot {TX}_{2 m} \cdot {RX}_{1 n} ,$$

where m and n are natural numbers. In FIG. 3B, this relationship is indicated as an example for m=1 and n=1 or n=2, where m corresponds to the particular transmission antenna element and n to the particular reception antenna element of the sensors. In other words, the product of the two indicated monostatic channels of the individual sensors is equal to the product of two redundant bistatic channels. This is used to evaluate correspondingly constructed measurement vectors. Here and below, only the case m=1 and n=1 or n=2 is shown as an example for the measurement vectors.

According to the third or fourth aspect, determining the association S10 can alternatively also be determining a control matrix A in which a bistatic l-th component A¹⁻²_{α1} of the control vector A corresponds to a product TX₁₁·RX₂₁, TX₁₁·RX₂₂ or TX₂₁·RX₁₁, TX₂₁·RX₁₂ of a particular measured first component TX₁₁ or TX₂₁ of a transmission control vector of a particular first of the radar sensors S¹ or S² and a particular measured second component of a reception control vector RX₂₁, RX₁₂ or RX₁₁, RX₁₂ Of a particular second of the radar sensors S² or S¹. Thus, components of one-way (transmission or reception) control vectors are combined. Correspondingly constructed measurement vectors comprising bistatic components are thus evaluated.

According to the second aspect, the method comprises the step of calculating S12 a measurement vector X associated with a detected radar target 300. The measurement vector X has x components Xₓ. The measurement vector X has at least bistatic components, summarized here as subvector X¹⁻². A bistatic l-th component X¹⁻²ₗ of the measurement vector X corresponds to a product TX₁₁·RX₂₁·TX₂₁·RX₁₁, TX₁₁·RX₂₂·TX₂₁·RX₁₂ of a measured value of a first bistatic channel TX₁₁·RX₂₁, TX₂₁·RX₁₁, Which measured value is associated with the radar target 300, and a measured value of a second bistatic channel TX₂₁·RX₁₁, TX₂₁·RX₁₂, which measured value is associated with the radar target 300. The first bistatic channel TX₁₁·RX₂₁, TX₂₁·RX₁₁ corresponds to an m-th transmission antenna element TX₁₁ of a particular first of the radar sensors S and an n-th reception antenna element RX₂₁, RX₂₂ of a particular second of the radar sensors S². The second bistatic channel TX₂₁·RX₁₁, TX₂₁·RX₁₂ corresponds to an m-th transmission antenna element TX₂₁ of the second radar sensor S² and an n-th reception antenna element RX₁₁, RX₁₂ of the first radar sensor S¹.

The measurement vector can have monostatic components, summarized here as subvectors X¹, X². A bistatic component of the measurement vector X¹⁻² corresponds to the specified product TX₁₁·RX₂₁·TX₂₁·RX₁₁, TX₁₁·RX₂₂·TX₂₁·RX₁₂ of bistatic channels. A monostatic component X¹, X² of the measurement vector X corresponds to a monostatic channel TX₁₁·RX₁₁, TX₁₁·RX₁₂, TX₂₁·RX₂₁/TX₂₁·RX₂₂ of the corresponding radar sensor S¹, S². As described above, the measured values of the two bistatic virtual channels TX₁₁·RX₂₁·TX₂₁·RX₁₁, TX₁₁·RX₂₂·TX₂₁·RX₁₂ are redundant.

Due to the correspondence described above between the bistatic l-th component A¹⁻²_{α1} of the control vector A_{α} associated with the angle α and the corresponding bistatic l-th component X¹⁻²ₗ of the measurement vector X, it is possible, according to the first or second aspect, to evaluate the product of the spectral values measured in the d, v spectrum in the two redundant bistatic channels TX₁₁·RX₂₁·TX₂₁·RX₁₁, TX₁₁·RX₂₂·TX₂₁·RX₁₂ for a radar target 300 for the angle estimation by means of corresponding bistatic components A¹⁻²_{α} of the control vectors X associated with the respective angles α.

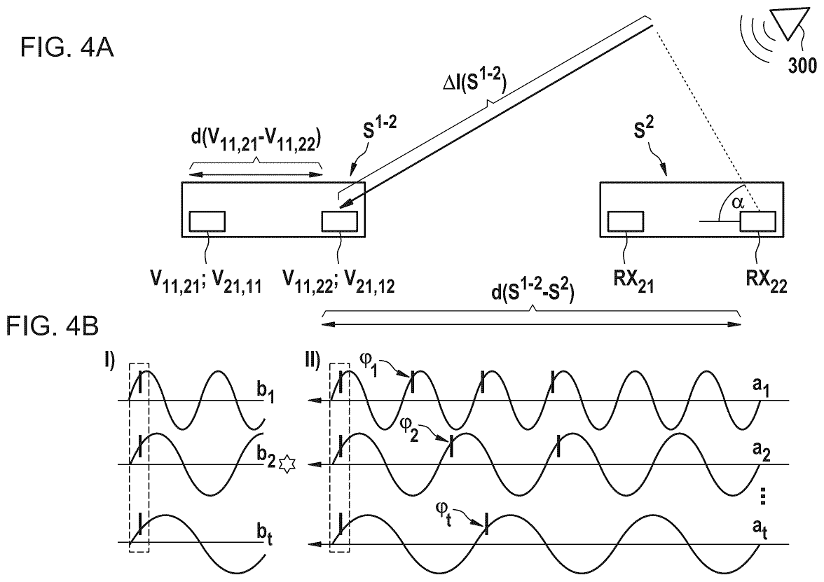

In step S50, which is shown schematically in FIG. 4A, the mutual spatial offsets d(S¹⁻²-S²) between two respective sensors that comprise one of the individual radar sensors S¹, S² and one of the at least one bistatic virtual sensor S¹⁻² are determined. The prerequisite for this is that a particular phase characteristic over the radar sensors S¹, S² can be determined on the individual radar sensors S¹, S² without ambiguity. This is the case for all sensors where a distance d(V_{11,21}-V_{11,22}) between at least two of the virtual antenna elements V_{11,21}; V_{11,22} is designed to be a maximum of λ/2. The respective sensors each receive a plurality of signals that are associated with respective radar targets 300 having different angles α. A phase φ of the signals received by the respective sensors is associated with each of the two sensors. An extrapolated spatial phase progression a₁, . . . aₜ across the channels, or transmission or reception antenna elements RX₂₁, RX₂₂, of the relevant sensor S² is associated, as shown by way of example in FIG. 4B-II, with each of the signals received by one of the relevant sensors S², wherein the radar targets 300 are numbered from 1 to t. The phase progressions a₁, . . . aₜ each associated with a different angle α and the relevant radar target 300 are different due to the angular dependence of the particular radar target 300. The particular phase characteristic b₁ . . . bₜ, as shown in FIG. 4B-I, of the signals of the other of the two sensors S¹⁻², which signals are associated with the particular radar target 300, results from a particular measurement vector.

Determining S50 comprises examining S52 correlations of the extrapolated spatial phase characteristics a₁, . . . at of the one of the two respective sensors S² with the respective measured phase characteristics b₁ . . . bₜ of the other of the two respective sensors S¹⁻². On the extrapolated spatial phase progressions a₁, . . . at of the one of the sensors S², spatial positions at which a particular (extrapolated) phase associated with the one of the sensors S² corresponds to a particular (measured) phase of the other of the sensors S¹⁻² are determined. This creates a plurality of hypotheses φ₁ . . . . φₜ for the different angles α for the position d(S¹⁻²-S²) of the other of the sensors S¹⁻². The position d(S¹⁻²-S²) at which, in the extrapolated spatial phase characteristics a₁, . . . aₙ, most hypotheses (dashed rectangle in FIG. 4B-II) match the respective measured phase characteristics b₁ . . . bₜ of the other of the two respective sensors S¹⁻² (dashed rectangle in FIG. 4B-I) corresponds to the desired position d(S¹⁻²-S²). The examination S52 of correlations comprises a convolution operation *, wherein the respective phase characteristics a₁, . . . aₜ*b₁ . . . bₜ associated with the relevant sensors S¹⁻², S² are convolved. The phase characteristics b₁ . . . bₜ of the signals received by the other of the two respective sensors S¹⁻² are inverted and scaled for the calculation. In the step of determining S54 the mutual spatial offset d(S¹⁻²-S²) between the two respective sensors S¹⁻², S² based on the results of the examination 52, the mutual spatial offset d(S¹⁻²-S²) between the two respective sensors S¹⁻², S² is determined by determining a particular maximum value of the result of the convolution operation a₁, . . . aₜ*b₁, . . . bₜ. In this way, the offsets of all real and virtual sensors relative to one another can be determined.

In step S40, the phases φ of the components of the particular control vector A_{α} are corrected based on a particular phase correction C_{α}, wherein the correction corresponds to a particular phase shift. The particular phase correction C_{α} comprises phase correction values of the form e^{-j·2·π·k} derived from a geometric relationship between the relevant sensors S¹, S², S¹⁻². In case of a bistatic product component TX₁₁·RX₁₁·TX₂₁·RX₂₁, TX₁₁·RX₁₂·TX₂₁·RX₂₂ of the control vector A_{α}, the phase shift can be twice a phase difference resulting from the run length difference Δl(S¹⁻²) due to the geometry for an angle α. For each sensor S¹, S², S¹⁻², the respective phase corrections C¹_{α}, C²_{α}, C¹⁻²_{α} of the components or subvectors A¹_{α}, A²_{α}, A¹⁻²_{α} of a control vector A_{α} of the particular sensor S¹, S², S¹⁻², which control vector is associated with an angle α, are identical, i.e., all components of the subvectors A¹_{α}, A²_{α}, A¹⁻²_{α} of the control vector A_{α} of the particular sensor S¹, S², S¹⁻² are corrected with the same phase correction C¹_{α}, C²_{α}, C¹⁻²_{α}. The particular phase correction C¹_{α}, C²_{α}, C¹⁻²_{α} depends on the angle α and the sensor S¹, S², S¹⁻².

In the step of correlating S20 the measurement vector X with the control vectors A_{α} that are associated with the different angles x, advantage is taken of the fact that the phase information of the individual components Xₓ of the measurement vector X is included in the estimation of the angle α, taking into account the corresponding control vector A_{α} corrected with the phase correction C_{α}. For this purpose, the measurement vector X is multiplied by a particular phase-corrected control vector A_{α} that is associated with an angle α corresponding to an angle hypothesis, or by the corrected control matrix A. The result is an angular spectrum associated with the detected radar target, from which angular spectrum the angle α can be estimated. In the simplest case, the angle α is estimated S30 by a maximum search in the particular angular spectrum obtained by means of the correlation S20. Thus, phase information of bistatic components of the measurement vector X is evaluated in order to carry out an angle estimation a taking into account bistatic channels TX₁₁·RX₂₁, TX₂₁·RX₁₁, TX₁₁·RX₂₂, TX₂₁·RX₁₂.

FIG. 2 is a schematic representation of a second embodiment of the method 100 for a cooperative radar sensor network 200 having a plurality of individual radar sensors S¹, S², for estimating S30 an angle α of a radar target 300. The radar sensor network 200 comprises a control and evaluation device 280 that is connected to the radar sensors S¹, S² and designed to perform the method 100. The method 100 according to the second embodiment comprises the above-described steps of determining S10 an association, calculating S12 a measurement vector X associated with a detected radar target 300, determining S50 the mutual spatial offsets d(S¹⁻²-S²), and estimating S30 the angle α based on the result of the correlation S20. Differences from the first embodiment are described below. The correlation S20 comprises a first correlation S22 of a first measurement vector X¹⁻² of at least one bistatic virtual sensor S¹⁻², which first measurement vector is associated with the detected radar target 300, with control vectors A¹⁻²_{α} of the bistatic virtual sensor S¹⁻², which control vectors are associated with different angles α. The bistatic virtual sensor S¹⁻² corresponds to a configuration of bistatic channels TX₁₁·RX₂₁, TX₂₁·RX₁₁, TX₁₁·RX₂₂, TX₂₁·RX₁₂ of the particular first radar sensor S¹ and the particular second radar sensor S² according to the first and second aspects or according to the third and fourth aspects. The correlation S20 furthermore comprises a second correlation S24 of a second measurement vector X¹, X² of at least one individual radar sensor S¹, S², which second measurement vector is associated with the detected radar target 300, with control vectors A¹_{α}, A²_{α}, of the individual radar sensor S¹, S², which control vectors are associated with different angles α. Thus, monostatic and bistatic sensors are initially evaluated individually in steps S22 and S24, respectively.

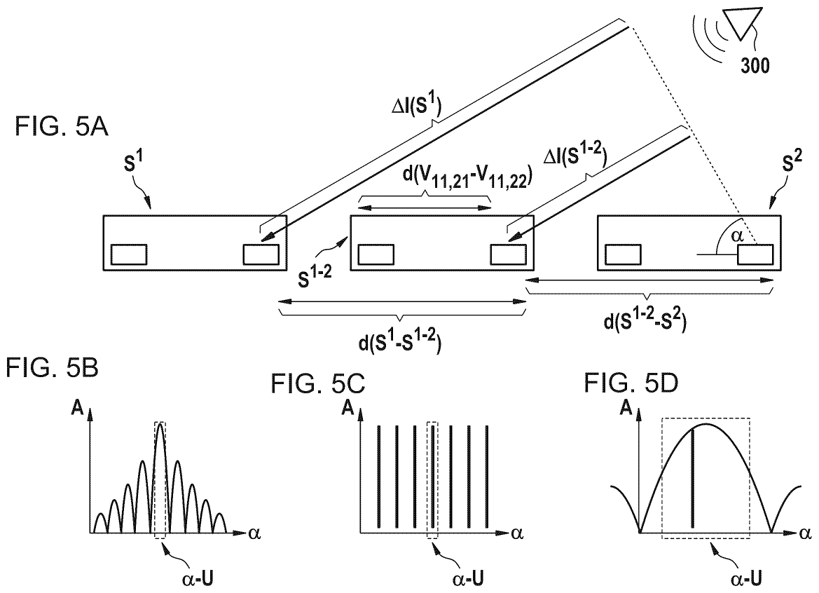

Estimating S30 the angle α of the detected radar target 300 comprises, as shown in FIG. 5A-5D and according to the fifth aspect, which may be part of the first to fourth aspects, determining S32 a phase vector that associates respective phases φ with the at least one bistatic virtual sensor S¹⁻² and the at least one individual radar sensor S¹, S², each of which phases is obtained based at least on the result of at least one of the first correlation S22 and the second correlation S24. The phase associated with the relevant sensor S¹, S², S¹⁻² corresponds to a phase φ of a particular complex value of the maximum of the absolute value of the particular angular spectrum, as shown in FIG. 5B. The phase vector is a vector whose components correspond to the phase values φ determined from the respective maxima of the angular spectra.

Estimating S30 comprises a third correlation S34 of the determined phase vector with phase vectors associated with different angles α. These phase vectors indicate phase relationships between the at least one individual radar sensor S¹, S² and the at least one bistatic virtual sensor S¹⁻² due to their mutual spatial offsets d(S¹⁻²-S²). The phase vectors associated with the different angles α are calculated from the mutual spatial offsets d(S¹-S¹⁻²), d(S¹⁻²-S²), d(V_{11,21}-V_{11,22}) between the respective sensors S¹, S², S¹⁻², as shown in FIG. 5A. For this purpose, a position vector is created from the mutual spatial offsets d(S¹⁻²-S²), the components of which position vector are the installation positions of the respective sensors S¹, S², S¹⁻². For calculating the position vector, any desired reference position, in particular a phase center of gravity of a reference channel, on the particular sensor S¹, S², S¹⁻² is used as the reference point for the particular sensor S¹, S², S¹⁻². The position estimation matrix P is produced from the position vector based on the geometric relationships of the relevant sensors S¹, S², S¹⁻² to one another. The position estimation matrix P has the following form, where d is the position vector and α is a particular angle of the radar target 300 and A is the radar wavelength:

$$P ( α , d ) = {e}^{\frac{j 2 π d}{λ} sin ( α )}$$

The rows of the position estimation matrix P thus correspond to phase vectors which are associated with different angles α and each of which indicates an angle-dependent phase relationship between the respective radar sensors S¹, S², S¹⁻² due to their mutual spatial offsets d(S¹-S¹⁻²), d(S¹⁻²-S²), d(V_{11,21}-V_{11,22}).

The third correlation S34 comprises determining an angular spectrum by multiplying the phase vector by the position estimation matrix P. Since only the offsets d(S¹-S¹⁻²), d(S¹⁻²-S²), d(V_{11,21}-V_{11,22}) of the sensors S¹, S², S¹⁻² relative to one another are considered for the third correlation S34, which offsets can be many times larger than the wavelength λ of the received signals, the particular angular spectrum has ambiguity, as shown in FIG. 5C. The ambiguity is characterized by the fact that, for a periodic angle α, a value that has the same amplitude or phase (and corresponds to the detected radar target 300 occurs.

Estimating S30 furthermore comprises determining S36 an ambiguous estimated value S36 for the angle α of the radar target 300 based on the result of the third correlation S34, as shown in FIG. 5D.

The angle α of the radar target 300 is determined by the step of resolving S38 the ambiguity of the estimated value for the angle α based on the particular angular spectrum of the first correlation S22 or the second correlation S24. A neighborhood x-U around a maximum of the angular spectrum, as shown in FIG. 5B, is chosen such that an estimated value of the ambiguous estimated value, as shown in FIG. 5C, falls within the neighborhood α-U. The refined angular resolution of the angle x at which a radar target 300 is detected is determined by multiplying the results of the first correlation S22 and/or the second correlation S24 by the result of the third correlation S34. A phase correction S40 is therefore unnecessary. The angular resolution is thus improved compared to the angle grid of the first or second correlation S22, S24, which angle grid corresponds to the angle grid of the calibration steps of the individual sensor. As a result of the first or second correlation, only the product of the measurement vector with the relevant control vector is required to estimate the angle α with a refined angular resolution.

However, in all embodiments, additional intermediate angle steps can be used for the correlations by interpolating the control matrix in step S10, or a finer angular resolution of the association of the phase vectors with the angles can be used in step S34 than the angular resolution in the correlation of steps S22 or S24, so that the angular resolution can be improved further, for example to 0.5° or 0.1°.

What is claimed is:

1. A method for a cooperative radar sensor network having a plurality of individual radar sensors, for preparing the cooperative radar sensor network for bistatic angle estimations, the method comprising the following steps:
determining an association that associates a respective control vector with each of a plurality of angles, wherein each respective control vector has at least bistatic components, wherein each bistatic 1-th component of each respective control vector corresponds to a product of:
a respective first monostatic component of a control vector of a respective first of the radar sensors, wherein the respective first monostatic component corresponds to a monostatic path from an m-th transmission antenna element of the first radar sensor to an n-th reception antenna element of the first radar sensor, and
a respective second monostatic component of a control vector of a respective second of the radar sensors, wherein the respective second monostatic component corresponds to a monostatic path from an m-th transmission antenna element of the second radar sensor to an n-th reception antenna element of the second radar sensor.

2. A method for a cooperative radar sensor network having a plurality of individual radar sensors, for estimating an angle of a radar target, the method comprising:
calculating a measurement vector associated with a detected radar target, wherein the measurement vector has at least bistatic components, wherein a bistatic 1-th component of the measurement vector corresponds to a product of:
a measured value of a first bistatic channel, which measured value is associated with the radar target and the first bistatic channel corresponding to an m-th transmission antenna element of a respective first of the radar sensors and an n-th reception antenna element of a respective second of the radar sensors; and
a measured value of a second bistatic channel, wherein the measured value is associated with the radar target and wherein the second bistatic channel corresponds to an m-th transmission antenna element of the respective second radar sensor and an n-th reception antenna element of the first radar sensor; and
estimating the angle of the detected radar target, wherein the estimated angle is determined based on a result of a correlation of the measurement vector with control vectors associated with different angles or based at least on a product of the measurement vector with a control vector.

3. The method according to claim 2, further comprising:
preparing the cooperative radar sensor network for bistatic angle estimations by:
determining an association that associates a respective control vector with each of a plurality of angles, wherein the respective control vector has at least bistatic components, wherein each bistatic 1-th component of each respective control vector corresponds to a product of:
a respective first monostatic component of a control vector of a respective first radar sensor of the radar sensors, wherein the respective first monostatic component corresponds to a monostatic path from an m-th transmission antenna element of the first radar sensor to an n-th reception antenna element of the first radar sensor, and
a respective second monostatic component of a control vector of a respective second radar sensor of the radar sensors, wherein the respective second monostatic component corresponds to a monostatic path from an m-th transmission antenna element of the second radar sensor to an n-th reception antenna element of the second radar sensor.

4. The method according to claim 3, further comprising:
(i) associating: (a) a first correlation of a first measurement vector of at least one bistatic virtual sensor, which first measurement vector is associated with the detected radar target, with (b) control vectors of the at least one bistatic virtual sensor, which control vectors are associated with different angles, wherein the bistatic virtual sensor corresponds to a configuration of bistatic channels of the respective first radar sensor and the respective second radar sensor, wherein the measurement vector of the bistatic virtual sensor has the bistatic components, and/or
(ii) associating: (a) a second correlation of a second measurement vector of at least one individual radar sensor, which second measurement vector is associated with the detected radar target, with (b) control vectors of the individual radar sensor, which control vectors are associated with different angles;
wherein the estimating of the angle of the detected radar target includes:
determining a phase vector that associates respective phases with the at least one bistatic virtual sensor and the at least one individual radar sensor, each of which phases is obtained based at least on a result of at least one of the first correlation and the second correlation;
determining a third correlation of the determined phase vector with phase vectors that are associated with different angles and indicate phase relationships between the at least one individual radar sensor and the at least one bistatic virtual sensor due to their mutual spatial offsets;
determining an ambiguous estimated value for the angle of the radar target based on a result of the third correlation; and
resolvin the ambiguity of the estimated value for the angle of the radar target based on a result of the first correlation or the second correlation.

5. The method according to claim 2, wherein the respective control vector associated with an angle is composed of monostatic components and the bistatic components, wherein each respective monostatic component is a component of a control vector of a relevant one of the radar sensors.

6. The method according to claim 5, further comprising:
correcting the phases of monostatic and bistatatic components of the respective control vector based on a respective phase correction that corresponds to a respective phase shift resulting for the respective angle from a mutual spatial offset between the respective sensors of the at least one individual radar sensor and at least one bistatic virtual sensor, wherein the bistatic virtual sensor corresponds to a configuration of bistatic channels of a respective first radar sensor and a respective second radar sensor.

7. The method according to claim 4, further comprising:
determining the mutual spatial offsets between two respective sensors of sensors that include the plurality of individual radar sensors and the at least one bistatic virtual sensor, based on signals of the two sensors from a plurality of detected radar targets each associated with different angles, wherein the determining includes:
examining correlations of phases of signals of one of the two respective sensors, which signals are associated with a respective radar target, with an extrapolated spatial phase characteristic of signals of the other of the two respective sensors, which signals are associated with the respective radar target, and
determining the mutual spatial offset between the two respective sensors based on results of the examination.

8. A method for a cooperative radar sensor network having a plurality of individual radar sensors, comprising:
preparing the cooperative radar sensor network for bistatic angle estimations, by:
determining an association that associates a respective control vector with each of a plurality of angles, wherein each respective control vector has at least bistatic components, wherein a bistatic 1-th component of each respective control vector corresponds to a product of:
a respective first component of a transmission control vector of a respective first radar sensor of the radar sensor, wherein the respective first component corresponds to an m-th transmission antenna element of the first radar sensor; and
a respective second component of a reception control vector of a respective second radar sensor of the radar sensors, wherein the respective second component corresponds to an n-th reception antenna element of the respective second radar sensor.

9. The method according to claim 8, further comprising:
estimating an angle of a radar target, by:
determining a measurement vector associated with a detected radar target, wherein the measurement vector has at least bistatic components, wherein a bistatic 1-th component of the measurement vector corresponds to a measured value of a bistatic channel, which measured value is associated with the radar target and which bistatic channel corresponds to an m-th transmission antenna element of the respective first radar sensor of the radar sensors and an n-th reception antenna element of the respective second radar sensor of the radar sensors, and
estimating the angle of the detected radar target, wherein the estimated angle is determined based on a result of a correlation of the measurement vector with control vectors associated with different angles or based at least on a product of the measurement vector with a control vector.

10. The method according to claim 9, further comprising:
(i) associating: (a) a first correlation of a first measurement vector of at least one bistatic virtual sensor, which first measurement vector is associated with the detected radar target, with (b) control vectors of the bistatic virtual sensor, which control vectors are associated with different angles, wherein the bistatic virtual sensor corresponds to a configuration of bistatic channels of the respective first radar sensor and the respective second radar sensor, wherein the measurement vector of the bistatic virtual sensor has the bistatic components, and/or (ii) associating: (a) a second correlation of a second measurement vector of at least one individual radar sensor, which second measurement vector is associated with the detected radar target, with (b) control vectors of the individual radar sensor, which control vectors are associated with different angles;
wherein the estimating of the angle of the detected radar target includes:
determining a phase vector that associates respective phases with the at least one bistatic virtual sensor and the at least one individual radar sensor, each of which phases is obtained based at least on a result of at least one of the first correlation and the second correlation,
determining a third correlation of the determined phase vector with phase vectors that are associated with different angles and indicate phase relationships between the at least one individual radar sensor and the at least one bistatic virtual sensor due to their mutual spatial offsets,
determining an ambiguous estimated value for the angle of the radar target based on a result of the third correlation, and
resolving the ambiguity of the estimated value for the angle of the radar target based on a result of the first correlation or the second correlation.

11. The method according to claim 8, wherein the respective control vector associated with a respective angle is composed of monostatic components and the bistatic components, wherein each respective monostatic component is a component of a control vector of a relevant one of the radar sensors.

12. The method according to claim 11, further comprising:
correcting phases of components of the respective control vector based on a respective phase correction that corresponds to a respective phase shift resulting for the respective angle from the mutual spatial offset between the respective sensors of the at least one individual radar sensor and at least one bistatic virtual sensor, wherein the bistatic virtual sensor corresponds to a configuration of bistatic channels of a respective first radar sensor and a respective second radar sensor.

13. The method according to claim 10, further comprising:
determining the mutual spatial offsets between two respective sensors of sensors that comprise the plurality of individual radar sensors and the at least one bistatic virtual sensor, based on signals of the two sensors from a plurality of detected radar targets each associated with different angles, wherein the determining includes:
examining correlations of phases of signals of one of the two respective sensors, which signals are associated with a respective radar target, with an extrapolated spatial phase characteristic of signals of the other of the two respective sensors, which signals are associated with the respective radar target, and
determining the mutual spatial offset between the two respective sensors based on results of the examination.

14. The method according to claim 10, further comprising:
refining, by interpolation, an angular granularity of the association that associates a respective control vector with each of a plurality of angles; or
in the estimation of the angle of the detected radar target, the angle is estimated with an angular granularity of less than or equal to 0.5°; or
the association of the different angles with the phase vectors has a smaller angular granularity in the third correlation than the association of the control vectors of the bistatic virtual sensor with the different angles (x) in the first correlation and/or than the association of the control vectors of the individual radar sensor with the different angles in the second correlation.

15. A cooperative radar sensor network having a plurality of individual radar sensors, comprising:
a control and evaluation device configured to perform a method for preparing the cooperative radar sensor network for bistatic angle estimations, the method comprising the following steps:
determining an association that associates a respective control vector with each of a plurality of angles, wherein each respective control vector has at least bistatic components, wherein each bistatic 1-th component of each respective control vector corresponds to a product of:
a respective first monostatic component of a control vector of a respective first of the radar sensors, wherein the respective first monostatic component corresponds to a monostatic path from an m-th transmission antenna element of the first radar sensor to an n-th reception antenna element of the first radar sensor, and
a respective second monostatic component of a control vector of a respective second of the radar sensors, wherein the respective second monostatic component corresponds to a monostatic path from an m-th transmission antenna element of the second radar sensor to an n-th reception antenna element of the second radar sensor.
